(19) United States
(12) Patent Application Publication
(10) Pub. No.: US 2018/0052053 A1
(43) Pub. Date: Feb. 22, 2018

(54) UNIVERSAL COLOR TAG AND TRACING SYSTEM

(71) Applicants: Don Atkinson, Delano, MN (US); EE Wong, Guangdong (CN)

(72) Inventors: Don Atkinson, Delano, MN (US); EE Wong, Guangdong (CN)

(21) Appl. No.: 15/110,218

(22) PCT Filed: May 12, 2016
(86) PCT No.: PCT/US16/32115

§ 371 Date: Jul. 7, 2016

Related U.S. Application Data
(60) Provisional application No. 62/160,349, filed on May 12, 2015.

(51) Int. Cl. G01J 3/52; G06K 7/14

(52) U.S. Cl. CPC G01J 3/524; G06K 7/1417; G06K 7/1413

(57) ABSTRACT

A color tag comprises a substrate having a visually detectable tint associated with a portion thereof and a code which reflects color information relating to individual color parameters of said visually detectable tint, as well as identity information that specifically identifies said color tag itself.

### FIELD OF THE INVENTION

The present invention relates generally to a universal color tag and tracing system and, more particularly, to individually identifiable ColourTracer™ color swatch tags which facilitate the real-time evaluation and location of any product associated with such a ColourTracer™ tag, while also enabling increased dialog and reliability in the measurement and comparison of a product's coloration, as defined by a specific ColourTracer™ tag.

### BACKGROUND OF THE INVENTION

The selection of color is oftentimes one of the most important decisions that is made in relation to the manufacture of a good or product. Indeed, when choosing a specific color it is necessary to be able to communicate, discuss and compare the constituent hues, pigments and related color parameters of a chosen color swatch, to third parties, manufacturing facilities and to the products themselves.

Commonly known color swatches are used to define a color visually, as well as numerically through color measurement instruments, and also as the comparative standard in the process of measured comparison of color. During the manufacturing process of inks, dyes, paint, plastic and textile products, color printing, and even in baked goods, color swatches have historically been used to both define the color to be produced, as well as to be the comparison vehicle used to measure against in evaluating that the manufactured color has been produced within an acceptable visual or measured tolerance of the originally chosen color swatch.

Thus, known color swatch books or catalogs are mass produced and distributed, which include hundreds or thousands of different colors, each having a proprietary code (e.g., ‘Red 138’) associate therewith. That is, known color swatch catalogs include color swatches with proprietary codes/designations that are intended to reflect the constituent hues, pigments and related color parameters of the color depicted on the color swatch itself, thereby theoretically enabling manufacturers to be able to exactly replicate the chosen color during subsequent manufacturing or coloration processes.

As will be appreciated, the proprietary code of commonly known and manufactured color swatches do not, themselves, directly communicate any of the constituent color parameters of a color swatch, requiring instead reference to a color data ‘key’ (a look-up table or the like) associated with each proprietary code. It is therefore very difficult if not impossible to determine the required constituent hues, pigments and related color parameters of the color swatch if one does not have access to the color data ‘key’ or database represented by the proprietary code, even if the proprietary code is known.

Of course, in current practice, known color swatches are mass produced in the hundreds or thousands of pieces, as many “identical” color swatches will need to be distributed for display, such as in hardware or paint stores, as well as in manufacturing facilities of all types. Once a particular color, and therefore a color swatch, is chosen, the act of using the color swatch to define a color, or as a comparison standard, will take place many, many times, in multiple locations, for multiple product types, often at the same time. Further, known color swatches are mass produced to address their limited shelf life, due to color fading from the prolonged exposure to light while waiting to be used.

But even in the best environment, the ability for the common color swatch to be an accurate device for defining and comparing color is limited by the inherent inaccuracies attributed to the manufacturing process of the color swatch itself.

In practice today, the inherent color differences between known color swatches, as detailed above, cannot be accounted for during the process of color evaluation of multiple products using multiple swatches. During the process of color measuring and comparing multiple products at different locations using multiple color swatches, there is simply no way to identify and effectively account for, or neutralize, the inherent differences that exist between individual color swatches, even when they are ostensibly the ‘same’ color swatch, depicting the ‘same’ color, marked with the same proprietary name/code.

Thus, the measured and applied color consistency of the products that use any common, mass produced color swatch as the comparison vehicle, can only be as consistent as the color swatches used in evaluating the consistency of the product color. Simply said, product colors can only be as consistent as the color swatches they are being compared to. In an ideal world, there would be only one master color swatch, which would not fade, which was used every time someone wanted to define, measure and compare that particular color. But of course this is not practical.

Contributing to the problem of accurate color measurement and comparison is the inherent level of inaccuracy existing within today's industry standard instruments used for measuring a color. This inaccuracy is sometimes defined as an inter-instrument disagreement. This “disagreement” means that the resulting color parameter values provided from two separate color measurement instruments are different from one another when measuring the very same color swatch, often providing very different color parameter values. Hence the need for a system of self-calibration that accommodates any such inter-instrument disagreements.

It will be readily appreciated that the result of inter-instrument disagreement, along with the inherent manufacturing inconsistencies in mass produced color swatches and ongoing color fade, compound on one another to greatly reduce the ability for any mass produced color swatch to accurately define a color and/or provide an accurate and consistent color point for comparative color measurement.

Thus, the present invention seeks to overcome these deficiencies in the art by proposing an universal color tag apparatus and tracing system, including the use of individually identifiable/serialized ColourTracer™ tags having readily accessible and integrated technology that facilitates accurate and real-time color evaluation and comparison.

### SUMMARY OF THE INVENTION

It is an object of the present invention to provide a system for universal color tracing.

It is another object of the present invention to propose individually identifiable/serialized ColourTracer™ color swatch tags.

It is another object of the present invention to propose individually identifiable/serialized ColourTracer™ tags having integrated technology that facilitates the tracing and evaluation of any individual ColourTracer™ tag at any point along a manufacturing and transportation process.

It is another object of the present invention to propose individually identifiable/serialized ColourTracer™ tags having integrated technology that is capable of distinguishing any individual ColourTracer™ tag from any other ColourTracer™ tag.

It is another object of the present invention to propose an individually identifiable/serialized ColourTracer™ tag that is capable of representing color parameter values via a non-proprietary code.

It is another object of the present invention to propose individually identifiable/serialized ColourTracer™ tags having integrated technology that records any differences in color parameter values that may exist between individual ColourTracer™ tags.

It is another object of the present invention to provide a method for the calibration of, and between, color measurement instruments.

These and other objectives of the present invention, and their preferred embodiments, shall become clear by consideration of the specification, claims and drawings taken as a whole.

### BRIEF DESCRIPTION OF THE DRAWINGS

FIG. 1 illustrates a ColourTracer™ tag with universal coding, in accordance with one embodiment of the present invention.

FIG. 2 depicts a calibration process for a color measurement device, in accordance with one embodiment of the present invention.

### DETAILED DESCRIPTION OF THE PREFERRED EMBODIMENTS

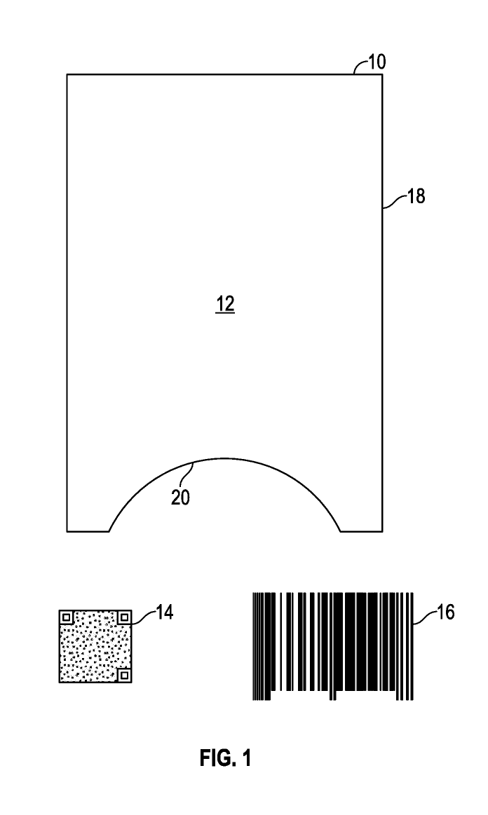

FIG. 1 illustrates a ColourTracer™ color swatch tag 10, in accordance with one embodiment of the present invention. As shown in FIG. 1, the ColourTracer™ tag 10 has a particular shade and coloration 12, the constituent components of which, including all color parameter values/data needed to replicate the exact coloration 12 as shown on the ColourTracer™ tag 10, are encapsulated in a QR code 14 and/or a bar code 16.

As will be appreciated, the QR code 14 and the bar code 16 are universally accessible codes. That is, both QR code 14 and the bar code 16 are easily decrypted by any number of well known devices, including modern smart phones having click and capture technology and related applications.

It is therefore one important aspect of the present invention that because each ColourTracer™ tag 10 integrates embedded identification technology, such as the QR code 14 and/or the bar code 16, any person having either a common bar code reader or QR reader can access the coloration information for each color swatch 10 without requiring access or reference to a proprietary ‘key’ or related proprietary database.

Indeed, by associating an universally accessible code with each ColourTracer™ tag 10, the present invention enables accurate and real-time determination of exact color data for a specific ColourTracer™ tag 10, greatly enhancing the communication of the same between all interested parties, and not just those who have access to some type of proprietary ‘key’, catalog or database, as will be discussed in more detail later.

It will, however, be readily appreciated to one of ordinary skill that although the ColourTracer™ tag 10 of FIG. 1 depicts the use of one or both a universal QR code 14 and a bar code 16, the present invention is not so limited in this regard. Indeed, the coding or embedded identification technology for the ColourTracer™ tag 10 may take any form and be of any nature, including being digital in nature or encapsulated via alternative visual identification recognition technology, without departing from the broader aspects of the present invention.

As also shown in FIG. 1, the ColourTracer™ tag 10 employs a substrate 18 which could be of any suitable material such as paper or plastic, but is preferably one which accepts colored ink or dye and enjoys heightened color retention qualities. An arcuate profile 20 may be present on some portion of the ColourTracer™ tag 10, in order to facilitate easier examination and analysis by color measurement devices.

The ColourTracer™ tag 10 may also be equipped with an adhesive backing, or portion thereof, that may be selectively exposed in order to affix the ColourTracer™ tag 10 to another object, for comparison purposes or the like, as desired. Of course, while the ColourTracer™ tag 10 shown in FIG. 1 has been depicted as having a substantially rectangular profile, the present invention is not so limited in this regard as the ColourTracer™ tag 10 may have any profile or shape, without departing from the broader aspects of the present invention. Likewise, although the coloration 12 of the ColourTracer™ tag 10 extends across the entire front plane of the ColourTracer™ tag 10, the present invention equally envisions a coloration section occupying only a portion of the front plane of the ColourTracer™ tag 10, in whatever shape or configuration, without departing from the broader aspects of the present invention.

In practical application, the present invention envisions multiple ColourTracer™ tags 10 being produced during a common manufacturing process and time, ostensibly representing the same exact color. A single, color measurement instrument records all relevant color parameter data for each ColourTracer™ tag in a non-proprietary code format associated with the ColourTracer™ tag 10 (as discussed above in connection with non-proprietary codes 14/16).

As discussed, and while the present invention has described encoding the color parameter data of a ColourTracer™ tag 10 in accordance with QR or bar codes 14/16 respectively, the present invention is not so limited in this regard as the non-proprietary color data may instead be encoded upon the ColourTracer™ tag 10 in any digitally or optically readable manner or form, without departing from the broader aspects of the present invention.

Returning again to the ColourTracer™ 10 of FIG. 1, the ‘first’ of the ColourTracer™ tags 10 created in a manufacturing process is assigned its specific color parameter values at the time of its manufacture by a single, common color measurement instrument. The common color measurement instrument also evaluates each subsequently produced ColourTracer™ tag 10 for color consistency against all of the other ColourTracer™ tags 10, in order to calculate and document the color differences that exist between each and every ColourTracer™ tag 10.

These documented differences between the color parameter data sets of each ColourTracer™ tags 10 may be stored in a related, if physically distant, database, or, as will be described in more detail later, within the digitally readable and non-proprietary code of the ColourTracer™ tags 10 itself.

It is therefore an important aspect of the present invention that, at the time of manufacture, each and every ColourTracer™ tag 10 is individually identified/serialized with, and identifiable by, its own universally readable and non-proprietary code. The universally readable and non-proprietary code contains not only information pertaining to the specific color parameters of the color represented on the specific ColourTracer™ tag 10, but also identifies the actual, physical tag itself. Thus, merely by scanning the universally readable and non-proprietary code of any ColourTracer™ tag 10, it is possible to verifiably differentiate that specific tag from any of the other ColourTracer™ tags manufactured at substantially the same time and place to have essentially the same color parameter set.

As it will be readily appreciated by those of ordinary skill in the art, the term “individually identifiable/serialized” means that each ColorTracer tag 10 is unique and can be individually identified so as to be differentiated from a different ColorTracer tag 10.

It will be readily appreciated that by utilizing a common color measurement instrument during the manufacture of multiple ColourTracer™ tags 10, each of which are ideally desired to have exactly the same color parameter profile, the incidence and magnitude of any inter-instrument disagreement may be largely minimized, if not eliminated. Moreover, to the extent that slight differences still may exist between the measured color parameters of one ColourTracer™ tag 10 as compared to any subsequently manufactured ColourTracer™ tag 10, the use of a common color measurement instrument ensures that these differences can themselves be discovered at the time of manufacture, and can therefore also be recorded on the ColourTracer™ tag 10, or on a remote, related database.

Indeed, it is a primary aspect of the present invention that, in a preferred embodiment, the universally readable and non-proprietary code of any ColourTracer™ tag 10 records any actual differences between each ColourTracer™ tag 10 that is manufactured at substantially the same time and place to have essentially the same color parameter set.

Thus, in its simplest form, the ColourTracer™ tag 10 is used, in a preferred embodiment, for defining and comparing the manufactured color of a product (printing inks, plastic colorants, fabric dyes, skin color, flooring color, etc.), to a known and constant comparison vehicle (i.e., the ColourTracer™ tag itself).

As will be further appreciated, given that the ColourTracer™ tag 10 is manufactured to incorporate the color parameter data from a color measurement instrument, and since each ColourTracer™ tag 10 can be digitally identified from one another, the ColourTracer™ tag 10 provides direct and actual color information on a specific color swatch, in manner not possible with currently known color swatches and related proprietary color data ‘keys’ catalogs.

Still further, since each ColourTracer™ tag 10 includes an associated code, or other embedded identification technology, containing the actual color parameter data of the specific coloration shown thereon, and since this color parameter data may be easily and openly accessed via an open database/code reader while simultaneously identifying each color swatch 10 individually, the present invention completely eliminates the need for a spectrophotometer to be utilized each time when the specific color parameter data set of a ColourTracer™ tag 10 is desired to be known.

Indeed, with each ColourTracer™ tag 10 being associated with specific color parameter values via embedded identification technology, combined with the ability to digitally identify each ColourTracer™ tag 10 specifically, the present invention eliminates the color patch inconsistency problem of comparing the color of a product swatch using several individual different color swatches at several different points in the process of manufacturing and supply chain color evaluation, as is currently the process in the industry because of the use of common color swatches having none of the capabilities of the ColourTracer™ tag 10 of the present invention. The ColourTracer™ tag's individualized color parameter data, and easy access to the same via its non-proprietary coding, enables the differences between each printed swatch to be quickly identified between color swatches and factored into (and out of) the visual or numerically measured evaluation of the product color to the ColourTracer™ tag 10.

As will be still further appreciated, each ColourTracer™ tag 10 enables an easy and efficient method for communicating in a very specific and focused way during and after the act of comparing the specific ColourTracer™ tag 10 to the manufactured product color. Thus, the ColourTracer™ tag 10 can leave a paper trail, or trace how, where, when and who has used the ColourTracer™ tag 10. Again, because of the ability to individually identify each ColourTracer™ tag 10, a dialog can be created and assigned to the individual ColourTracer™ tag 10 through the act of just digitally identifying/scanning the ColourTracer™ tag 10, via its embedded identification technology.

In a preferred embodiment, a specific color for a product is chosen and multiple ColourTracer™ tags 10 are manufactured at substantially the same time and place, to have essentially the same color parameter set. Each of the ColourTracer™ tags 10 are then encoded with their own specific color parameter values by a single, common color measurement instrument.

After the manufacturing and encoding of the ColourTracer™ tags 10 has taken place, they are immediately placed in light tight dispenser package(s), thereby ensuring that each of the ColourTracer™ tags 10 is in a light tight environment up until the moment it will be used. It will be readily appreciated that the enclosure essentially eliminates any problems associated with light fade, ensuring that the color parameter values taken during the manufacturing process is precise, accurate and reliable at the moment when each of the ColourTracer™ tags 10 is used.

All of the ColourTracer™ tags made in connection with a common product and desired coloration may be housed within the same light tight dispenser, or in separate light tight dispensers, without departing from the broader aspects of the present invention.

As discussed previously, each ColourTracer™ tag is integrated with a common, preferably digitally accessible identification technology, which enables each separate ColourTracer™ tag to be individually identifiable/serialized, digitally unique and easily differentiated from any other ColourTracer™ tag. This integration enables, among other things, the ability to assign each individual ColourTracer™ tag with its own separate database. The individual database of one ColourTracer™ tag is then linked to a network of all other individual ColourTracer™ tag databases. Each individually assigned database therefore enables the color parameter values of each separate ColourTracer™ tag, and the measured color differences between ColourTracer™ tags, to be easily stored, accessed and referenced, without the current requirement of an expensive and specialized spectrophotometer, and the specialized expertise to operate it.

It is therefore yet another important aspect of the present invention that a user needs only a common cellphone to access the pre-assigned color parameter values and color difference values for each and every ColourTracer™ tag in the world.

In addition, due to the ability to digitally identify each individual ColourTracer™ tag, the ColourTracer™ tag may be physically affixed to a manufactured product or container, and the location and/or transport identity and path of that precise product or container can be easily determined with absolute integrity. Thus, the ColourTracer™ tag of the present invention affords its users with another level of functionality that is heretofore unknown in common color swatches.

Historically, the act of comparing a common color swatch to a product for comparison inevitably generates a dialog in order to communicate and document approval or disapproval of the product, or to facilitate further discussion. As currently known, this dialog is conducted either in person, written on a piece of paper and attached to the product, or by means of a phone call or as a separately drafted email or text. In each of these communication methods, the dialog is generated separately as a stand alone process, apart and not in any way integrated or connected to the color swatch itself. There is no means or functionality provided from known color swatches which enables this inevitable dialog to be initiated through or directly connected to the use of the color swatch itself.

By way of further example, the present invention could be utilized in an approval process where it is mandatory that a product's color must be verified and approved to match the color parameters of a ColourTracer™ tag 10, within a specified tolerance, before production can begin. In this example, the printing press operator scans the ColourTracer™ tag 10 to bring up a dialog box in which he must send the printed color data results and/or a picture of the results to his boss for approval. His boss would approve the results and send the approval back. At the same time, the approval is copied to the client, so they are informed simultaneously that the printed color has been approved. Or for example, the ColourTracer™ tag 10 can be employed to reliably record the time and date the printing run was produced. Thus, by scanning the ColourTracer™ tag 10 and entering the appropriate information, there is a paper trail of the ColourTracer™ tag 10 and of when the job was produced, where, what time and what the special colors were for any particular press run.

Additionally, the ColourTracer™ tag 10 could be incorporated with a smartphone, or like device, to capture the color parameter information contained in the QR code, and at the same time send the data automatically up to the cloud for color approval or to look for complimenting colors of various products on the internet.

Still further, the present invention enables brand owners who use a ColourTracer™ tag 10 as a color comparison and color management device, to be assured that their brands can be as color consistent and accurate as the database consistency of ColourTracer™ tag 10 they incorporate into their color management process. This is not and cannot be determined by any other color standard or color swatches heretofore known.

While a ColourTracer™ tag 10 having a single coloration 12, or portion thereof, has been described, the present invention is not so limited in this regard. That is, the present invention equally contemplates that the ColourTracer™ tag could depict two or more colors on a single ColourTracer™ tag, either as, e.g., two solid blocks of separate color, or as a multiple, integrated color printed image from a digital printer or from a traditional printing press. Multiple-coloration ColourTracer™ tags 10 could be employed for color evaluation and color measurement of a printed picture or photo, essentially displaying what the color of the printed image should be, so that it can be used as for visual or image-capture and color evaluation, during the manufacturing process of printed materials. This could be a convectional printing press, digital printer, fabric dying or silk screen printing. In all of these cases, an image can be printed to some type of substrate, and the multiple-coloration ColourTracer™ tags 10 would be used as a comparison vehicle.

The ColourTracer™ tag is therefore designed to provide and enable these functionalities directly through the ColourTracer™ tag itself. Due to the ability to uniquely identify each individual ColourTracer™ tag, the ColourTracer™ tag affords its users with the ability to launch, foster, conduct and archive a ColourTracer™ tag specific dialog directly from using the ColourTracer™ tag itself. A user simply scans the specific ColourTracer™ tag to launch an integrated and connected dialog that is automatically specific to the scanned ColourTracer™ tag and the associated act of comparing it to a product color. Further, this functionality can be selectively utilized to track and archive the time, location, person and even photographs of the color comparison event.

While the present invention has been described in connection with a novel ColourTracer™ tag that is individually identifiable/serialized, it may still be necessary to utilize commonly known color swatches that have no such embedded identification technology from time to time. Indeed, regardless of the type of color swatch utilized, and once a particular color has been chosen, it is oftentimes necessary to be able to confirm that a manufacturing or coloration process is faithfully replicating the specific color chosen. In such circumstances, a color measurement device, such as a spectrophotometer, is oftentimes utilized to expose and analyze the product being manufactured, thereby determining the constituent hues, pigments and related color parameters of the product. These results are then compared to contractual or technical tolerances to determine if the product sufficiently matches the intended color.

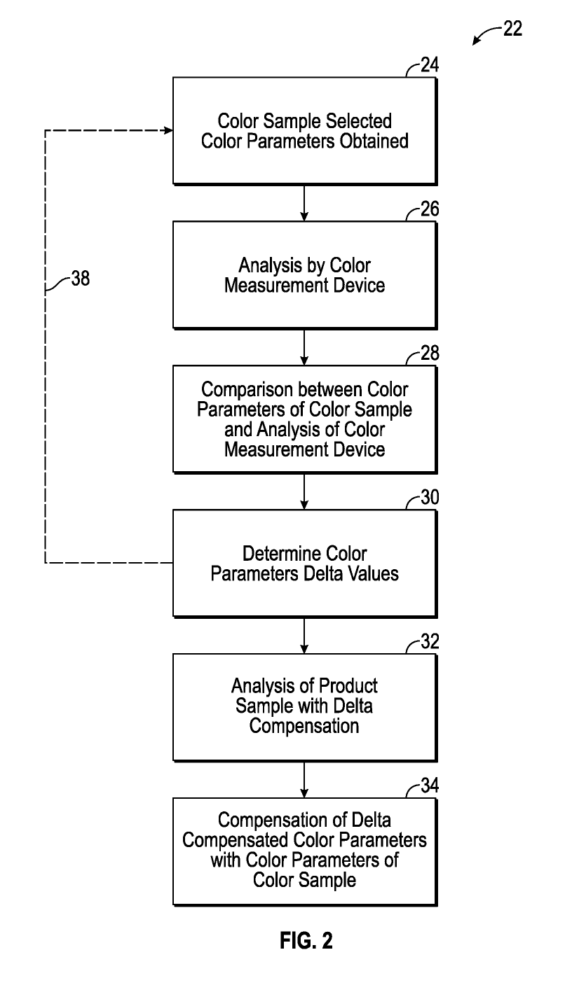

FIG. 2 depicts a calibration process 22 for ensuring proper calibration of any such color measurement device, so that differing devices made by differing manufacturers, and employed at differing times in differing locations, can all be assured that their individual results can be reliably compared to one another, regardless of the mechanical tolerances and environmental conditions of each color measurement device.

A specific color swatch 10 is selected, and the actual, constituent hues, pigments and related color parameters of the color swatch itself are determined, in step 24. It will be readily appreciated that the actual color parameter data values of a chosen color swatch may be determined directly, through the scanning of universal codes 14/16 as discussed in connection with the ColourTracer™ tag, or as a result of accessing the proprietary database connected with commonly known color swatches, without departing from the broad aspects of the present invention.

Returning to FIG. 2, once the actual color parameters of a particular color swatch 10 are known, the chosen color measurement device (e.g., a spectrophotometer; not shown in FIG. 2) performs an analysis of the color swatch 10, in step 26. The results of the exposure and analysis of the color swatch 10 in step 22 are then compared to the actual, known color parameters of the color swatch 10, in step 28.

In step 30, the result of the comparison in step 28 provides a series of delta values for each color parameter that represents constituent hues, pigments and related color data. It will therefore be readily appreciated that the delta values reflect the exact difference between what the color measurement device should be recording when analyzing the color swatch 10, and what it is in fact recording, for each color parameter representing constituent hues, pigments and related color data. Indeed, the delta values derived in step 30 will be specific to each individual color measurement device, in dependence upon its specific design, condition, and environmental condition at the time of its use.

Once the delta values have been determined in step 30, it will be readily appreciated that subsequent exposure of a product swatch by the same color measurement device need only be adjusted in accordance with these delta values, in step 32, in order to reliably ensure that the analysis of the color measurement device is accurate. Thus, any such calibrated color measurement device will have the ability to reliably confirm whether the color of the product swatch does, or does not, fall within required tolerances as compared to the chosen color swatch 10, as determined in step 34.

As will be readily appreciated, the results of any analysis by a color measurement device that has been calibrated in accordance with the calibration process 22 will be a repeatable and accurate reflection of the actual color parameters of the product swatch itself, and not a skewed result affected by the mechanical tolerances or environmental contamination of the color measurement device.

Indeed, the calibration process 22 of the present invention enables much greater reliance upon the analysis of any color measurement device that has heretofore ever been known. Thus, for example, manufacturing lines may be halted only when necessary; that is, when a calibrated analysis indicates that the color of a product swatch has diverged beyond acceptable tolerances, in real time with the manufacturing of the product itself. Likewise, the manufacture of inferior product can be reliably avoided, all due to the increased reliability of a calibrated color measurement device.

Still further, the results of a product swatch that is analyzed in one geographic location, using a first pre-calibrated color measurement device, may be reliably compared to the results of a subsequent analysis of the very same product swatch, even if the secondary analysis is completed at a second geographic location using a wholly separate, but also pre-calibrated, color measurement device.

Returning again to FIG. 2, and as depicted in step 38, it is further envisioned that the calibration process 18 described in connection with steps 24-30 may be selectively repeated, as needed or on a predetermined interval, in order to assure that even a previously calibrated color measurement device is constantly updating its compensation delta values, as lighting, temperature and other environmental and operational conditions change.

The calibration process 22 is therefore wholly independent of the manner in which the specific color parameter values of the color swatch 10 have been derived. Thus, whether the color parameters of a specific color swatch have be derived from a proprietary code or database, or whether they have been decoded in real time by virtue of scanning an universal QR code or bar code (such as embedded in the ColourTracer™ tag 10, shown in FIG. 1), the calibration process 22 of the present invention is equally capable of ensuring accurate and repeatable results from any color measurement device.

As will be readily appreciated, the ColourTracer™ tags 10 can be utilized and referenced on an individual basis to track color evaluation process at each essential stage within their manufacturing processes. In addition, it is another important aspect of the present invention, that because the color parameter data of each ColourTracer™ tags 10 is pre-assigned, any color inaccuracy inherent in each ColourTracer tags 10 is clearly identified and accounted for, and therefore prevents the ColourTracer to be considered as the source of any color difference error by its user.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A color tag, said color tag comprising:
a substrate, said substrate having a visually detectable tint associated with a portion thereof;
a code associated with said substrate; and
wherein said code reflects color information relating to individual color parameters of said visually detectable tint, as well as identity information that specifically identifies said color tag itself.

2. The color tag of claim 1, wherein:
said code is a non-proprietary digitally readable code.

3. The color tag of claim 1, wherein:
said color tag further comprising an adhesive layer on said substrate.

4. The color tag of claim 1, wherein:
said visually detectable tint comprising an arcuate profile.

5. The color tag of claim 1, wherein:
said code further reflects the color differences between each color tag that is manufactured at substantially the same time and place to have essentially the same said color parameters.

6. The color tag of claim 1, wherein:
said substrate further comprises another visually detectable tint which is different than said visually detectable tint.

7. The color tag of claim 1, wherein:
interrogation of said code of said color tag communicates information parameters of said color tag to a database.

8. The color tag of claim 7, wherein:
said information parameters include a time stamp of when said code was interrogated.

9. The color tag of claim 7, wherein:
said information parameters include measured color differences between said color tag and other color tags.

10. The color tag of claim 7, wherein:
said information parameters include a location where said code and said color tag were interrogated.

11. The color tag of claim 7, wherein:
said information parameters include an identity of one who accomplishes said interrogation.

12. A color tag, said color tag comprising:
a substrate, said substrate having a visually detectable tint associated with a portion thereof;
a code associated with said substrate, said code reflecting color information relating to individual color parameters of said visually detectable tint; and
wherein said code is a non-proprietary digitally readable code.

13. A method of calibrating a color measurement device, said method comprising the steps of:
choosing a color sample to be tested;
determining the intended color parameter values of said color sample;
analyzing said color sample with said color measurement device, said analysis determining actual color parameter values of said color sample;
determining the differences between each color parameter value of said intended color parameter values and each color parameter value of said actual color parameter values; and
applying said differences in each of said color parameter values to subsequent color parameter values generated by said color measurement device.
